(19) United States
(12) Patent Application Publication
(10) Pub. No.: US 2016/0098558 A1
(43) Pub. Date: Apr. 7, 2016

(54) SYSTEM, METHOD AND COMPUTER-ACCESSIBLE MEDIUM FOR SECURITY VERIFICATION OF THIRD PARTY INTELLECTUAL PROPERTY CORES

(71) Applicant: New York University, New York, NY (US)

(72) Inventors: VIVEKANANDA VEDULA, Austin, TX (US); JEYAVIJAYAN RAJENDRAN, Dallas, TX (US); ARUNSHANKAR DHANDAYUTHAPANY, New York, NY (US); RAMESH KARRI, New York, NY (US)

(21) Appl. No.: 14/874,794

(22) Filed: Oct. 5, 2015

Related U.S. Application Data
(60) Provisional application No. 62/059,373, filed on Oct. 3, 2014.
(60) Provisional application No. 62/235,890, filed on Oct. 1, 2015.

(51) Int. Cl. G06F 21/55

(52) U.S. Cl. CPC G06F 21/55; G06F 2221/034

(57) ABSTRACT

An exemplary system, method and computer-accessible medium for detecting the presence of a Trojan(s) in a circuit(s), can include, for example, receiving information related to a property(s) configured to determine the presence of the Trojan(s), and determining the presence of the Trojan(s) based on the property(s) and a design(s) of the circuit(s) using a bounded model checking tool.

### CROSS-REFERENCE TO RELATED APPLICATION(S)

This application relates to and claims priority from U.S. Patent Application Nos. 62/059,373, filed on Oct. 3, 3014, and 62/235,890, filed on Oct. 1, 2015, the entire disclosures of which are incorporated herein by reference.

### FIELD OF THE DISCLOSURE

The present disclosure relates generally to the verification(s) of third party intellectual property (“IP”) (“3PIP”), and more specifically, to exemplary embodiments of an exemplary system, method and computer-accessible medium for security verification of 3^{rd} party intellectual property cores.

### BACKGROUND INFORMATION

Fabless System-on-a-Chip (“SoC”) designers combine (3PIP) cores with in-house to design SOCs. They then outsource the fabrication and test phases of the SOCs. 3PIP vendors, foundries and test companies are distributed throughout the world. A SoC designer can use their service to meet the tight time-to-market deadlines, and to reduce the design, fabrication and test costs.

Notwithstanding its benefits, globalization of the SoC design flow has created opportunities for rogue elements within the supply chain to corrupt the integrated circuits (“ICs”). (See, e.g., References 1-3). Rogue elements in a foundry can alter a design, or include malicious circuits (e.g., called hardware Trojans), during fabrication. Similarly, rogue elements in the 3PIP companies can insert Trojans into their own IP. The inserted Trojans can be conditionally triggered or always on. (See, e.g., References 2 and 3). When triggered, a Trojan can result in a deadlock or failure of the system (e.g., overt attack), or can create a backdoor facilitating the attacker to gain remote access to the system (e.g., a covert attack). (See, e.g., References 2 and 3).

To provide a trustworthy SoC design, it can be beneficial to ensure the trustworthiness of the 3PIPs. However, since this may not always be possible, the SoC integrator should ensure that all the security vulnerabilities in any of the 3PIPs can be detected, or their effects muted, before they can damage the system.

Since 3PIPs can typically be delivered as Register Transfer Level (“RTL”) VHSIC Hardware Description Language (“VHDL”)/Verilog codes, code coverage analysis has been used on RTL codes to identify suspicious signals that can potentially be a part of a Trojan. (See, e.g., Reference 5). Since even a 100% coverage of the RTL code in a design does not guarantee that it can be fault-free (see, e.g., Reference 6), there is no guarantee that the 3PIPs can be trustworthy.

In another set of techniques, it has been proposed to analyze the 3PIP code, and mark suspicious signals. (See, e.g., References 7 and 8). The SoC integrator can then manually analyze these signals, and identify any Trojans. This technique, however, may also not guarantee Trojan detection, and can burden the SoC integrator by requiring them to manually identify the Trojans. In such a case, Trojan detection capability can depend on the skill of the SoC integrator. Furthermore, researchers have successfully bypassed this Trojan detection technique. (See, e.g., References 9 and 10). While probability analysis can be used to mark suspicious signals, controllability and reachability metrics can also be used to mark suspicious signals. (See, e.g., References 7 and 8).

Alternately, the SoC integrator, and a 3PIP vendor, can agree on a pre-defined set of security-related properties, and the SoC integrator can check the 3PIP against these properties. (See, e.g., Reference 11). However, a design methodology to develop the security-related properties for a 3PIP can be beneficial.

Thus, it may be beneficial to provide an exemplary system, method and computer-accessible medium for security verification of 3^{rd} party intellectual property cores, which can overcome at least some of the deficiencies described herein above.

### SUMMARY OF EXEMPLARY EMBODIMENTS

Exemplary system, method and computer-accessible medium for detecting the presence of a Trojan(s) in a circuit(s), according to an exemplary embodiment of the present disclosure, can include, for example, a receipt of information related to a property(s) configured to determine the presence of the Trojan(s), and a determination of the presence of the Trojan(s) based on the property(s) and a design(s) of the circuit(s) using a bounded model checking tool. The exemplary design(s) can include a software description of the circuit(s). The determination procedure can include a generation of a Boolean formula(s) using the BMC tool. Particular values can be assigned to the Boolean formula(s) using a satisfiability solving engine. An indication of the presence of the Trojan(s) can be generated if the Boolean formula(s) evaluates to 1 using the particular values.

According to certain exemplary embodiments of the present disclosure, it can be possible to include a bound(s). The determination procedure can be further based on a bound(s), which can be a particular number of clock cycles. The property(s) can include a detection that Trojan(s) can leak a secret(s). The property(s) can also include a detection that the Trojan(s) can leak a subset(s) of the secret(s). The property(s) can further include a detection that the Trojan(s) can be triggered over a plurality of clock cycles, or a direct polarity(s) and an indirect polarity(s).

In some exemplary embodiments of the present disclosure, assignments to an input of the configuration over a plurality of clock cycles can be determined using the property(ies). The determination procedure can be based a set of inputs over the clock cycles that violate the property(ies). The property(ies) can be or include a strict avalanche criterion property. The strict avalanche criterion property can be determined, for example, using at least two seeds for a pseudo random number generator.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary schematic diagram of an exemplary AES design with a hardware Trojan according to an exemplary embodiment of the present disclosure;

FIG. 2 is an exemplary flow diagram illustrating an exemplary property for determining the presence of a Trojan according to an exemplary embodiment of the present disclosure;

FIG. 3 is a schematic diagram of a trigger control in multiple clock cycles according to an exemplary embodiment of the present disclosure;

FIG. 4 is an exemplary graph illustrating the number of bits leaked and the number of key-bit output pairs according to an exemplary embodiment of the present disclosure;

FIG. 5 is a flow diagram of an exemplary method for determining the presence of a Trojan in a configuration according to an exemplary embodiment of the present disclosure; and

FIG. 6 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures, when taken in conjunction with the appended claims.

### DETAILED DESCRIPTION OF EXEMPLARY EMBODIMENTS

The exemplary system, method and computer-accessible medium, according to an exemplary embodiment of the present disclosure, to detect malicious or undesirable circuits, gates or properties (e.g., a Trojan) in 3PIP using assertions. Specifically, Trojans that leak secret information (e.g., cryptographic key, plaintext or intermediate computation) from the IP can be targeted.

Model checking can be used to detect Trojans. The input to the exemplary model checker can be the target property, and a formal description of the design in temporal logic, which can be a representation of the design as sequence of states. The output of the exemplary model checker can be a set of states which can satisfy the given property, or a witness of a sequence which can violate the property.

In the exemplary detect mechanism, the target property can be provided such that the design should not leak any confidential information. If the exemplary design violates this property, it can be classified as infected with a Trojan; otherwise, can be classified as Trojan-free. In addition to identifying Trojan-infected designs, the exemplary system, method and computer-accessible medium can generate the witness (e.g., set of inputs over several clock cycles) that can trigger the malicious behavior. The SoC integrator can use this witness in case of a dispute and to expose the Trojan.

Exemplary advantages of the exemplary system, method and computer-accessible medium can include, for example:
i) use with any cryptographic procedure;
ii) not burdening the SoC integrator by having them manually analyzing the code;
iii) substantially guaranteeing detection of Trojans, if the IP code has Trojans. If not, the exemplary system, method and computer-accessible medium can conclude that the design can be Trojan-free;
iv) use in conjunction with property-based Trojan detection procedures (see e.g., Reference 11); and/or
v) generation of the trigger condition for the Trojan.

### Exemplary Threat Model

The SoC designer can buy, or otherwise obtain, IP from the 3PIP vendors for a SoC design to meet the time-to-market constraints and reduce the design effort. The 3PIP vendor can deliver the IP in an RTL netlist form or a gate-level netlist form. The 3PIP vendor can be the attacker, and the SoC integrator can be the defender.

An exemplary objective of the attacker can be to subvert the security of the SoC design, which can be using the IP. For this purpose the attacker can introduce hardware Trojans into the IP. A 3PIP designer can insert Trojans whose triggers and payload characteristics can be “digital.” For example, the characteristics of the Trojans do not depend on any physical characteristics of the SoC design such as power and timing. This can be because the attacker (e.g., 3PIP vendor) has little or no control over the synthesis constraints of the SoC designer. Thus, the attacker cannot design a Trojan that depends on the physical characteristics of the SoC design as these characteristics can be determined by the synthesis constraints. Since the SoC synthesis does not alter the digital functionality of the 3PIP, an attacker can use a Trojan whose trigger and payload characteristics can be digital. Note that this assumption can be consistent with the other 3PIP Trojan detection procedures.

An exemplary objective of the defender can be to detect Trojans; if there can be any, in the 3PIP. If there are no Trojans in the 3PIP, the defender should be able to conclude that the 3PIP can be Trojan-free. It can be assumed that the defender has access to the RTL/gate-level netlist of the 3PIP since they are buying the 3PIP. Thus, the defender can run functional simulations on this 3PIP and/or can subject it to functional verification. Furthermore, the defender can know the functionality of the input and output ports of the 3PIP as specified in the specification. For example, consider a 3PIP implementing a cryptographic encryption procedure. The defender can know the input port where the plaintext has to be applied, and the input port where the secret key has to be applied.

### Exemplary Trojans in Cryptographic ICs

Since no single Trojan detection procedure can guarantee detection of all Trojans (see, e.g., References 2 and 3), researchers usually design procedures that target a specific class of Trojans. Trojans in cryptographic ICs can be considered because, for example:
i) many researchers have successfully demonstrated this class of Trojans (see, e.g., References 14-16);
ii) most of the Trojans are in the Trust-Hub Trojan repository (see, e.g., Reference 12);
iii) Trojans that modify functionality or deny service can be detected by concurrent error detection (“CED”) procedures. However, CED procedures may not detect leakage of information; and
iv) most of the SoC designs can be equipped with cryptographic modules to speed-up computation. (See, e.g., References 17 and 18).

For example, Trojans that leak secret information can be considered; the secret information can be plaintext, secret key or any of the intermediate computations.

### Exemplary Methods in Hardware Design

Ensuring the correct functionality of a complex hardware design can be a complex process. While simulation-based testing methods remain the primary way to validate the hardware design, its effectiveness in assuring production-level quality can be severely limited. Formal methods (see, e.g., Reference 19), have emerged as an alternate approach to ensure that the safety-critical components of the design can be exhaustively tested for correctness. These exemplary methods include application of mathematical approaches to specify the quality criteria and to validate the design against this criterion.

Quality criteria can be specified using properties described in temporal logic and variations, following work in verifying reactive programs. (See, e.g., Reference 20). Exemplary properties which can express system behavior can be classified as safety and liveness properties. (See, e.g., Reference 21). A safety property can express the fact that “something bad will never happen.” A liveness property can express the behavior whereby “something good will eventually happen.”

In Linear Time temporal logic (“LTL”), the notion of time can be that of a linearly ordered set (e.g., this can be thought of as a possible sequence of states). One of the operators used to describe LTL properties in dealing with hardware verification can be Gq. It can express that q can be true at every moment of the future.

### Exemplary Bounded Model Checking

The process of analyzing a design for the validity of properties stated in temporal logic can be called model checking. The input to a model checker can be a formal description of the design in temporal logic, and the result can be a set of states which can satisfy the given property, or a witness of a sequence which can violate the property.

Efficient Procedures have been developed to manipulate Boolean formulas in model checking using Ordered Binary Decision Diagrams (“OBDD”s). (See, e.g., Reference 22). It has also been illustrated that LTL model checking can be reduced to computational tree logic (“CTL”) model checking with fairness constraints. (See, e.g., Reference 23). The use of OBDDs can facilitate the analysis of designs without explicitly enumerating their states. However, OBDDs can also be vulnerable to the state explosion problem for even moderately complex designs.

In practice, designers can know the bounds on the number of steps within which a property should hold. This can lead to Bounded Model Checking (“BMC”), where the property, can be determined to hold within a finite sequence of state transitions. In this exemplary approach (see, e.g., Reference 24), a Boolean formula can be derived from the property, and the design under verification (“DUV”) can be satisfiable if and only if the underlying state transition system can realize a finite sequence of state transitions that can reach certain states of interest. The exemplary Boolean formula that can be formed can be given to a satisfiability solving (“SAT”) engine, and if a satisfying assignment can be found, that assignment can be a witness for the path segment of interest. If such an assignment cannot be found at a given length k, the search can be continued for a larger k.

### Exemplary Formal Methods in Hardware Security

Previously, verification procedures have been used to detect side-channel attacks. SAT-based procedures can be used to detect fault attacks. (See, e.g., Reference 25). Satisfiability Modulo Theories (“SMT”)-based procedures have been used to evaluate the strength of software countermeasures for side-channel attacks. (See, e.g., Reference 26). The detection of the Trojans using property checking has also been proposed. (See, e.g., Reference 11). The exemplary system, method and computer-accessible medium, according to an exemplary embodiment of the present disclosure, can express the searching for a Trojan in the form of a property or an assertion. The property or assertion, and a design of a circuit, can be input into a bounded model checking tool, which can formulate a Boolean formula to be satisfied or proved. A SAT engine can attempt to assign values in the Boolean formula such that the Boolean formula evaluates to 1. This can be used to determine the presence of the Trojan being searched for.

### Exemplary Assertion-Based Trojan Detection

Exemplary Trojans that Leak Keys

A Trojan, which leaks a secret information s, can bijectively map s to an output port o ε O, where O can be the list of output ports. In case of crypto designs, s can be the secret key, plaintext or any intermediate computation. In order to detect this Trojan, the exemplary system, method and computer-accessible medium, according to the an exemplary embodiment of the present disclosure, can utilize quality criteria that can be specified as an LTL property, for example, as follows:

∀iεI [symbol] P [symbol] G [symbol] (s==o)

where I can be the set of input ports of the design expressed as a program P. This exemplary property can seek to ensure that for every possible input in the exemplary design, it can be globally true that the secret information may not be equal to any of the output ports.

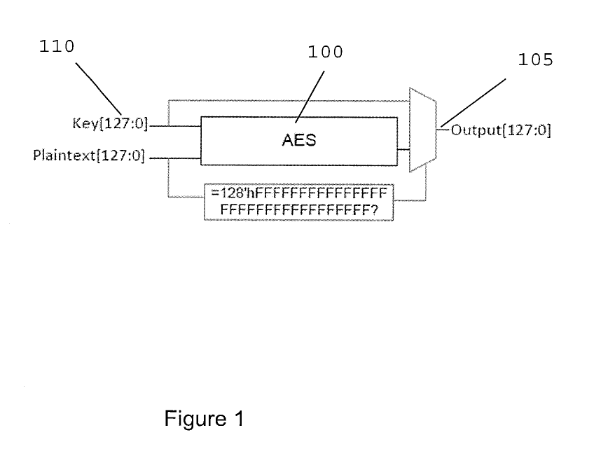

For example, consider the AES design 100 shown in FIG. 1. The Trojan can leak the secret key through the output 105 when the plaintext can be 128′hFFFFFFFFFFFFFFFFFFFFFFFFFFFFFFFF. Here, the Trojan can bijectively map each bit of key 110 to the corresponding bit of the output.

### Exemplary Properties to Detect Trojans

A property can be described as an embedded Verilog assertion. For example:

Property 1: Detect Trojans that leak secret.

| design_under_test instantiation_1{ | |
|---|---|
| .inputs(inputs), | |
| .secret1(secret), | |
| .outputs1(outputs) }; | |
| design_under_test instantiation_2{ | |
| .inputs(inputs), | |
| .secret2(secret), | |
| .outputs2(outputs) }; | |
| assign secret1 = 1′b0; | |
| assign secret2 = 1′b1; | |
| assert | (!((outputs1 == secret1) |
| | && (outputs2 == secret2))) |

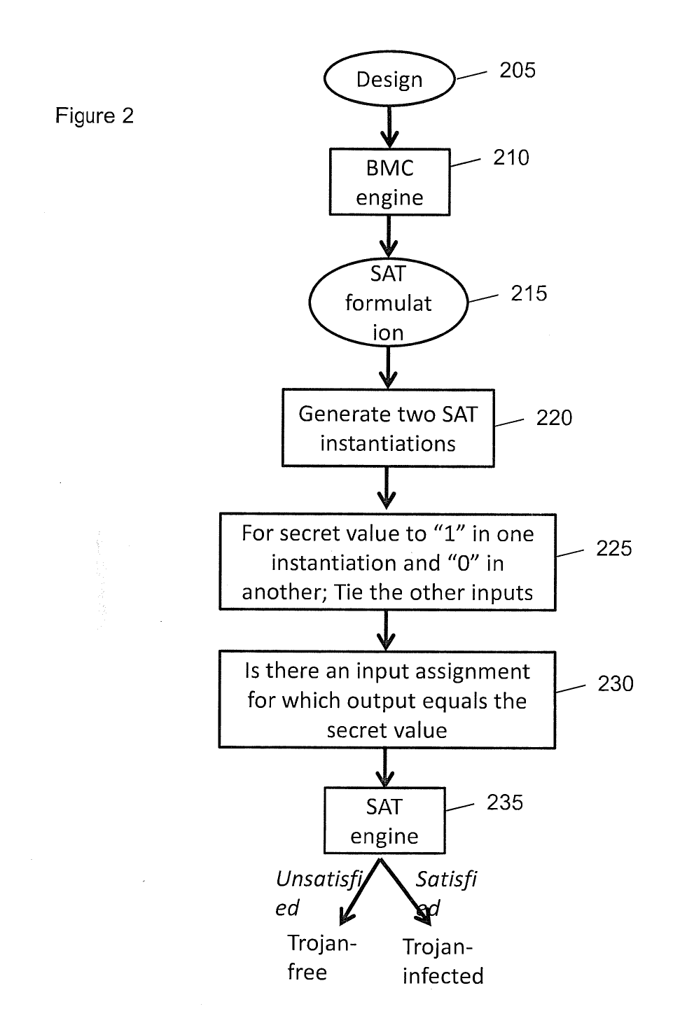

For example, as shown in the flow diagram of FIG. 2, a BMC engine 210 can take the Verilog representation of the design 205 along with Property 1 and can derive a SAT formulation 215 for validating the property. In order to check for bijective mapping, the Trojan leaks the secret can be determined when the secret value of the secret can be either 1 or 0. Two copies of the design under test can be instantiated at procedure 220. The secret values forced to logic can be in one copy, and logic Os can be in another copy at procedure 225. Furthermore, the other inputs of two copies can be tied together. The SAT engine can look for an input assignment that can bijectively map the secret to the output, irrespective of the secret value at procedure 230. At procedure 235, if there exists an assignment, then the property can declare that there exists a Trojans; otherwise, it can declare that the design does not have a Trojan the leaks the secret key.

Exemplary Trojans that Leak a Subset of Secret Information

While the Trojan shown in FIG. 1 leaks all the 128 bits of the secret key, Trojans can also leak only a subset of key-bits. While Property 1 can be used to detect Trojans that leak only a subset of key-bits, there can exist 2128 about possible subsets, making it computationally infeasible to check for all possible subsets.

The exemplary system, method and computer-accessible medium, according to an exemplary embodiment of the present disclosure, can be used to detect these kinds of Trojans, by using, for example, an assertion for leakage of individual bits of the secret key. Exemplary property 2 indicated below lists the assertion that detects a Trojan that can leak a subset of the secret information. For example, it can check if bit 0 of the secret information can be leaked. All the other bits of the secret information and the inputs, can be left unassigned and tied together. This way, the exemplary SAT engine can attempt to find an assignment to an input, and the other bits of the secret that bijectively maps bit 0 of the secret to any of the outputs, irrespective of the value of bit 0. If there exists an assignment, then the property can declare that there exists a Trojans; otherwise, it can declare that the design does not have a Trojan that leaks the secret key.

Property 2. Assertion to detect Trojans that leak
a subset (bit 0) of secret.

| design_under_test instantiation_1{ | |
|---|---|
| .inputs(inputs), | |
| .secret1(secret), | |
| .outputs1(outputs) }; | |
| design_under_test instantiation_2{ | |
| .inputs(inputs), | |
| .secret2(secret), | |
| .outputs2(outputs) }; | |
| assign secret1 = secret[:1]& 1′b0; | |
| assign secret2 = secret[:1]& 1′b1; | |
| assert | (!((outputs1 == secret1) |
| | && (outputs2 == secret2))) |

### Exemplary Triggers Over Multiple Clock Cycles

The trigger for a Trojan can arrive at multiple clock cycles. In such exemplary cases, the assignments to the input over multiple clock cycles have to be determined. The exemplary system, method and computer-accessible medium, according to an exemplary embodiment of the present disclosure, can use a G operator—for such determination. Exemplary Property 3 provided below illustrates the assertion using the G operator. When using this operator, the exemplary BMC can unroll the design for multiple clock cycle, and can attempt to find a set of input assignments at multiple clock cycles to violate this property.

Property 3. Assertion to detect Trojan that gets
triggered over multiple clock cycles

assert G (((outputs1 == secret1) && (outputs2 == secret2)))

For example, consider the AES-T800 design from the Trust—hub benchmark suite. This Trojan can leak the key bits [7:0] of AES on applying four plaintexts in consecutive clock cycles (see Table I below). Because of the above assertion, the exemplary BMC can unroll the design for four clock cycles, and can find these plaintexts that can trigger the Trojan.

TABLE 1
Trojan detection results

| | Benchmark characteristics | | | Assertion results | | |
|---|---|---|---|---|---|---|
| S. No | Name | Bits leaked | Trigger condition | Result | Memory (GB) | Total time (s) |
| 1 | AES-T100 | Key bits 0 to 7 | Always on | Detected | 3.92 | 96.1 |
| 2 | AES-T200 | Key bits 0 to 7 | Always on | Detected | 3.92 | 94.23 |
| 3 | AES-T600 | 128 bits of key | When plaintext | Detected | 3.97 | 96.8 |
| | | | is 128′hf | | | |
| 4 | AES-T700 | Key bits 0 to 7 | When plain text | Detected | 3.95 | 96.33 |
| | | | is 128′h00112233 | | | |
| | | | 445566778899aabbccddeeff | | | |
| 5 | AES-T800 | Key bits 0 to 7 | On applying the following | Detected | 3.95 | 96.86 |
| | | | plain texts consecutively | | | |
| | | | 128′h3243f6a8885a3 | | | |
| | | | 08d313198a2e0370734 | | | |
| | | | 128′h0011223344556 | | | |
| | | | 6778899aabbccddeeff | | | |
| | | | 128′h0 | | | |
| | | | 128′h1 | | | |
| 6 | AES-T900 | Key bits 0 to 7 | When the number of | Detected | 3.94 | 96.12 |
| | | | clock cycles reaches | | | |
| | | | 128hffffffffffffffffffffffffffffffff | | | |
| 7 | AES-T1000 | Key bits 0 to 7 | When plain text is | Detected | 3.95 | 96.55 |
| | | | 128′h00112233445566 | | | |
| | | | 778899aabbccddeeff | | | |
| 8 | AES-T1100 | Key bits 0 to 7 | On applying the following | Detected | 3.96 | 96.57 |
| | | | plain texts consecutively | | | |
| | | | 128′h3243f6a8885a3 | | | |
| | | | 08d313198a2e0370734 | | | |
| | | | 128′h0011223344556 | | | |
| | | | 6778899aabbccddeeff | | | |
| | | | 128′h0 | | | |
| | | | 128′h1 | | | |
| 9 | AES-T1200 | Key bits 0 to 7 | When the number of | Detected | 3.94 | 96.87 |
| | | | clock cycles reaches | | | |
| | | | 128hffffffffffffffffffffffffffffffff | | | |
| 10 | AES-T2000 | 128 bits of key | When plaintext is | Detected | 3.90 | 94.92 |
| | | | 128′h3243f6a8885a3 | | | |
| | | | 08d313198a2e0370734 | | | |
| | | | 128′h0011223344556 | | | |
| | | | 6778899aabbccddeeff | | | |
| | | | 128′h0 | | | |
| | | | 128′h1 | | | |
| 11 | RSA-T100 | 32 bits of key | When plaintext is | Detected | 0.27 | 2.31 |
| | | | 32′h44444444 | | | |
| 12 | RSA-T300 | 32 bits of key | Every alternate usage | Detected | 0.28 | 2.48 |

Exemplary Direct Polarity vs. Inverse Polarity

A Trojan can be said to leak the secret through an output port if there can exist a bijective mapping between them. If there can exist a direct (e.g., inverse) mapping, the leakage can be called direct (e.g., inverse) polarity. Exemplary Property 4 provided below lists two assertions that can detect Trojans that leak secret information through direct and inverse polarities, respectively.

Property 4. Assertions to detect direct and inverse polarities

| | |
|---|---|
| assert G | (((outputs1 == secret1) && (outputs2 == secret2))) |
| | /*direct polarity*/ |
| assert G | (((outputs1 != secret1) && (outputs2 != secret2))) |
| | /*inverse polarity*/ |

### Exemplary Detection OF Entropy Corruption

A Trojan which attempts to corrupt the secret information by making it vulnerable to Cryptanalysis can try to reduce the randomness of the corresponding secret information by reducing its entropy from the cryptographic standard. When applying a trigger, the entropy of secret can be reduced from 2N+x, where N can be the number bits the LFSR possesses and x can be the additional functionality added to increase the randomness for maintaining the Cryptographic standard.

Formally, it can be defined as, for example:

∃trigger [symbol] P [symbol] S(si)<2^{N+x}∀siεSI (1)

### Exemplary Strict Avalanche Criterion Property

The exemplary BMC tool can verify if the given property can be satisfied to prove the correctness of the exemplary design. The SAC can be said to be satisfied if, whenever a single input bit can be complemented, each of the output bits can change with a probability of one half (See, e.g., Reference 27). This property can be satisfied by all Cryptographically secured pseudo random number generator (“PRNG”). To formally verify the entropy correctness in a cryptographic system, a property can be derived using the SAC condition. Thus, for example:

∃sd1,sd2εI [symbol] (H(sd1,sd2)==1)

[symbol]

P [symbol] (H(si1,si2)>N/2)∀siεSI (2)

The exemplary Property in the above equation can check for the condition for any two seed inputs to a Cryptographic PRNG with Hamming distance of one, which can result in the outputs having the Hamming distance greater than N/2, where N is the total number bits the seed possesses. Any Cryptographic PRNG may satisfy this condition.

### Exemplary Detection of Trojans Triggers in Multiple Clock Cycles

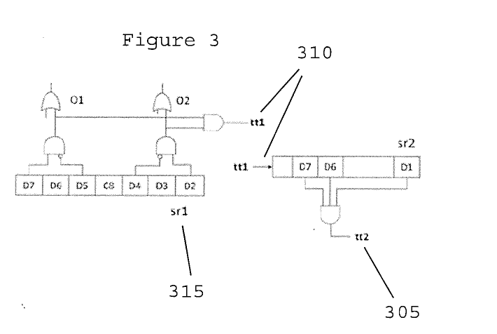

There exist Trojans whose trigger vector can arrive over multiple clock cycles. The previous property cannot detect such Trojans. Consider the Trojan trigger design in FIG. 3 (see, e.g., Reference 28) where the signal tt2 (element 305) triggers the Trojan activation in UT Tyler Trojan benchmark. To make signal tt1 (element 310) high, input sequence for LFSR sr1 (element 315) to can be “1X0X0X1”. tt2 can be high after receiving three logic “1” inputs of tt1 at different clock cycles to make D1, D1 and D1 registers to be at logic “1”. In order to make the signal tt2 high by the BMC tool, the input assignment of LFSR sr1 should be controlled by the BMC tool in more than just one clock cycle. Thus, for example:

G∃sd1,sd2εI [symbol] (H(sd1,sd2)==1)

[symbol]

P [symbol] (H(si1,si2)>N/2∀siεSI (3)

To detect such Trojans, the assignments to the input over multiple clock cycles can be determined. The exemplary Property above can use the G operator. The exemplary BMC can unroll the design for multiple clock cycles and can try to find a set of input assignments over those clock cycles that can violate this property.

### Exemplary SAC Property Implementation

An exemplary procedure can be used to derive the SAC property and to formally verify it. seed1 and seed2 can be the two seeds for PRNG function. Secret_out1[N] and Secret_out2[N] can be the PRNG outputs for the corresponding seed inputs. Hamming Calc( ) can be the function to calculate the Hamming distance between the two signals. Seed_cond can be the condition for the seed inputs to have hamming distance of one. Secret_cond is the SAC condition for the secret outputs from PRNG to have hamming distance greater than or equal to N/2. BMC can try to make the Final Property under test to be logic “0” by taking all the rare trigger condition to prove the Trojan presence. This makes the exemplary BMC tool make Seed_cond be at logic “1” by selecting the corresponding seed inputs and Secret can be at logic “0” by taking the rare Trojan trigger conditions if so any. This exemplary procedure implemented in Verilog/VHDL to result the Final_Property in a single clock cycle.

### Exemplary Finite Number of Clock Cycles

In BMC, the number of clock cycles to unroll can be fixed and given by the user. As the simulation complexity increases with the increase in the number of clock cycles, the exemplary BMC can be performed for a limited number of clock cycles. Thus the trustworthiness for the first N clock cycles, where N is the maximum number of clock cycles for which BMC can be performed can be evaluated. For clock cycles≧N, the trustworthiness of the design may not be guaranteed.

### Exemplary Results

### Exemplary Experimental Setup

A third party IP on which the Trojan verification can be performed can be instantiated twice into the wrapper which can force the LSB of the input to verify whether it can be connected to the output to value 1 for one instantiation and to value 0 for another instantiation.

The exemplary system, method and computer-accessible medium, according to an exemplary embodiment of the present disclosure, can make an assertion in a way that there should never, or almost never, be a condition where that particular input bit can be equal to any of the output bits in both of the instantiations. If this is the case, it can be inferred that the particular bit can be a direct connection to the output port.

A symbolic model verifier (“SMV”) can reach the state where this output can match with the input in both cases to prove the property given in the assertion condition to be wrong. The same procedure can be used to detect the inverse polarity.

Verilog assertions for the Entropy corruption property can be generated for the designs in the benchmark suite CSAW-2013. These assertions were embedded into the respective designs and provided as input to the BMC engine of the SMV tool from Cadence. (See, e.g., Reference 29). An Intel(R) Xeon E5-2450L 32 cores CPU with 128 GB memory operating at 1.80 GHz has been used to run the simulations. It is possible to use the benchmarks in which the Trojans that corrupt the entropy of information and are triggered by digital inputs were used. This can be because, e.g., (i) the procedure can target Trojans that corrupt information and (ii) in the exemplary threat model, the malicious 3PIP vendor has no control over the design constraints imposed on the SoC by the SoC integrator.

TABLE II
Detecting Trojans that corrupt the Entropy of the Secret information. We used
Trojan structures of Trojan benchmarks from CSAW 2013.

| | Benchmark characteristics | | | Detection results | | |
|---|---|---|---|---|---|---|
| S. No | Name | Cellular Automata? | Trigger condition | FANCI [8] | VeriTrust [9] | Our technique |
| 1 | UT Tyler [21] | Yes | Triggers sequentially after | Not detected | Not detected | Detected |
| | | | corresponding seed | | | |
| 2 | Iowa Sate | No | Three clock cycles after | Not detected | Not detected | Detected |
| | | | making counter value “0001” | | | |
| 3 | MoMA_Avengers | Yes | Every alternate clock cycle | Not detected | Not detected | Detected |

Algorithm 1: Entropy Corruption Detection.

```
Input : seed1[N], seed2[N]
Output: Property
PRNG_uut1(seed1[N], Secret_out1[N]) :
PRNG_uut2(seed2[N], Secret_out2[N]) ;
Seed_cond = (Hamming_Calc(seed1[N], seed2[N]) == 1):
Secret_cond = (Hamming_Calc(Secret_out1[N],Secret_out2[N])
≧ N/2):
Final_Property = Secret_cond | ~(Seed_cond);
assert : G Final_Property:
Hamming_Calc(in1,in2);
for i ≦ N do
  | temp [i] = in1[i] ⊕ in2 [i];
  | i++;
end
temp2 = temp[0] + temp[1] +..+ temp[N];
return temp2:
```

### Exemplary Detection Capability

A design can be infected with an Entropy corruption Trojan even if SAC property can be failed in any one of the states. Consider the Trojan in UT Tyler which can be activated sequentially by two input and gates once the required seed vector can be inputted. In case of the Iowa State Trojan benchmark, the trigger can arrive in three clock cycles after making a counter to a specific digital sequence. All these rare signals can be triggered by the BMC tool to activate the Trojan to prove its presence.

The exemplary procedure can be oblivious to the structure of the Trojan. For example, UT Tyler (see, e.g., Reference 29) can corrupt the Entropy in Cellular Automata based PRNG, while Iowa State can corrupt the entropy by creating barrel shift register.

The exemplary procedure can also be independent of the underlying procedure; it can detect Trojans in any design.

The last two columns in Table II show the memory usage and the time taken. The memory usage can be high because the exemplary BMC can make multiple copies of the design for the number of clock cycles unrolled. However, the memory usage can be within the limits of a modern processor, thus making it feasible to check for several hundred clock cycles. Furthermore, all the Trojans can be detected within 150 seconds. Checking for the final property did not result in any false negatives as it detected all the Trojans. To check for false positives, Entropy corruption on Trojan-free designs from the same benchmark suite. The exemplary system, method and computer-accessible medium, according to an exemplary embodiment of the present disclosure, did not flag these designs as Trojan-infected.

Exemplary Number of Clock Cycles for which the Property is Checked

For a design in CSAW-2013, the trigger can arrive after or within twelve clock cycles for all the Entropy corrupting Trojan Benchmarks. Maximum number of clock cycle used to detect the Trojan's presence can depend upon its trigger and payload requirements. Thus, it can be beneficial to perform BMC for the maximum possible number of clock cycles.

Table III herein shows the maximum number of clock cycles for which SMV can unroll a design and check for the final property. For this experiment, the maximum memory usage was set to 16 GB. In case of Iowa State design, for more than eleven thousand clock cycles can be unrolled. However, in case of other two Cellular Automata designs, only a few hundred clock cycles can be unrolled. This can be because memory usage of the Cadence SMV tool can increase with the increase in state variables. CA designs can have more state variables than LFSR based PRNG designs. Nevertheless, all the Trojans were detected.

If these exemplary designs do not have Trojans, the trustworthiness of the designs for the number of clock cycles unrolled can be guaranteed. Beyond this, no security guarantees can be offered. To be prudent, the SoC integrator has to reset the design once the number of clock cycles exceeds this value. Since the exemplary design was unrolled for several hundred clock cycles, the integrator needs to reset it every several hundred clock cycles, leading to a throughput penalty of less than 1%.

### Exemplary Trojan Detection Analysis

Trojans leaking secret information in cryptography IP's can be experimented in SMV with an assertion that can make the Trojan trigger to leak the secret information. Table I above provides the Trojan trigger condition, and its characteristics to leak the secret information with memory and time to detect first bit leakage. The memory and time used by the exemplary SMV can depend on the depth at which the Trojan can be embedded in each exemplary design.

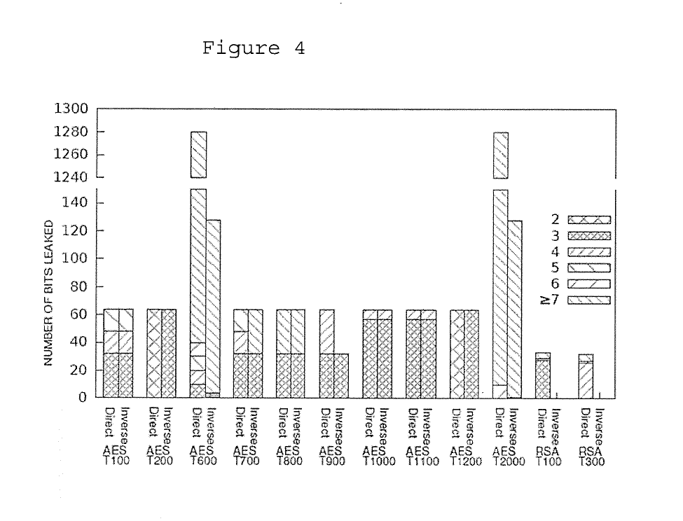

In AES-TI00, the first eight Key bits can be connected to the output port by XORing with the internal register with values of some random value which can be shifted in each clock cycle so that all the bits of the internal register can get both 0 and 1 in any one of the clock cycles. This can make the connection of a Key bit to the output port to be in both inverse, and in the same polarity. SMV can be asserted in such a way that it can check for the Key bit leakage in either of the polarity and detect it. The exemplary graph of FIG. 4 illustrates the various Key bit leakage detected in various clock cycles. For AES-T100 it can be inferred that Key bit leaks can be detected at third, fourth, and fifth clock cycles for both the same and the inverse polarity because the number of 1's and 0's can be the same in each state, but those locations can vary at different clock cycles to leak different bits.

The exemplary AES-T200 architecture can resemble AES-T100 except that the internal register which can be XOR′d to the Key bits can be connected to plain text value. The “Z” operator used in the exemplary SMV execution can make all uninitialized registers 0, which can gives the direct path between key bits to the output in the second clock cycle which can be inferred from FIG. 4. Additionally, when the SMV operates with the assertion to check for the inverse polarity of the Key bit in the output port, it can take plain text to be all l's so that the internal register connected to the Key bit connecting to output port can take a plain text value of all l's in the third clock cycle after getting cleared by the “Z” operator.

In AES-T600 and AES-T2000, all the 128 bits of Key input can be connected to the multiple output ports with both the same and the inverse polarity. A Trojan can be triggered with corresponding plain text pattern inferred from Table I. From FIG. 4, it can be inferred that there can be 1280 Key bit leaks to the output port with the same polarity, and 128 connections with inverse polarity. SMV can take those plain text patterns and make the Key bit to be leaked to the output to prove the Trojan presence.

AES-T700, AES-T800, AES-T1000 and AES-TI100 have the same architecture as AES-T100, where the internal register can be initialized to some random variable. Table I shows the plain text value which can be taken to trigger the Trojan to shift the bits of internal register in order to leak the Key bits in different clock cycles. From FIG. 4, it can be inferred that in both the same and inverse polarity verification of a Key bit to the output after the initial leak, the leakage of other key bits can be detected after the Trojan trigger condition can be reached by the SMV.

In AES-T900, the internal register XOR′d with Key bit connecting to output can be initialized with some random value, and the Trojan can be triggered after about 2A128 clock cycles. Since the “Z” operator in SMV execution can clear the internal register to all 0's, the SMV can detect all the Key bit connections to the Output port with the same polarity. Because the initialized value of internal register can have an equal number of 1's as 0's, which can facilitate the detection of about 32 inverse polarity connections of Key to output port. The remaining approximately 32 connections may not be detected because the memory of the machine running SMV may not have enough memory to reach 2A128 clock cycles, even though in AES-T1200 the Trojan can be triggered after 2A128 clock cycles. (See., e.g., FIG. 4). The internal register can take the value from plain text irrespective of the Trojan trigger condition. Thus, the exemplary SMV has full control over the selection of the plain text value, so the internal register can take all 0's in the second clock cycle because of the “Z” operator, or all l's in third clock cycle to detect the same and inverse polarity connection of Key to the output port in the corresponding clock cycles.

In RSA-T100, it can be inferred from Table I that the Trojan can trigger based on the plain text value to leak the about 32 bit key through the output port, where as in RSA-T300, the Trojan can be triggered for every alternate usage which can leak the key through the output port. SMV can reach these states to leak the key bits to prove the Trojan's presence.

### Exemplary Maximum Clock Cycle Analysis

Table III provided below shows the maximum clock cycle the SMV can reach for each design to detect the Trojan. Memory of the machine running the SMV can be the constraint which can control the maximum clock cycle which the SMV can reach. Memory used can depend upon the number of combinational and state variables used by the SMV to prove a property to be false. Memory usage can increase exponentially with the increase in state variables. Total time can also depend upon the number of state and combinational variables.

TABLE III
Maximum clock cycle reaches by SMV when there is a direct and inverse mapping
between a key bit and an output port.

| | | Same polarity | | | Inverse polarity | | |
|---|---|---|---|---|---|---|---|
| S. No | Name | Max clock cycle | Memory used (GB) | Total time (s) | Max clock cycle | Memory used (GB) | Total time (s) |
| 1 | AES-T100 | 4400 | 10.66 | 379.12 | 2535 | 12.33 | 155.06 |
| 2 | AES-T200 | 7605 | 11.83 | 174.61 | 2351 | 13.79 | 298.33 |
| 3 | AES-T600 | 1042 | 12.46 | 151.75 | 1642 | 12.45 | 152.41 |
| 4 | AES-T700 | 1203 | 10.57 | 198.15 | 815 | 11.19 | 276.98 |
| 5 | AES-T800 | 1483 | 13.17 | 155.48 | 1583 | 13.52 | 160.36 |
| 6 | AES-T900 | 740 | 13.21 | 1368.93 | 3540 | 14.19 | 169.36 |
| 7 | AES-T1000 | 1640 | 12.26 | 152.52 | 1640 | 12.26 | 153.51 |
| 8 | AES-T1100 | 1656 | 13.76 | 162.0 | 1655 | 13.77 | 161.85 |
| 9 | AES-T1200 | 870 | 13.50 | 1094.01 | 840 | 13.78 | 1385.64 |
| 10 | AES-T2000 | 970 | 12.46 | 180.16 | 1002 | 12.81 | 165.5 |
| 11 | RSA-T100 | 220 | 13.56 | 1247.77 | — | — | — |
| 12 | RSA-T300 | 160 | 6.453 | 394.99 | — | — | — |

### Exemplary Secret Information Leakage Detection in Different Clock Cycle

FIG. 4 also shows the exemplary graph indicating the number of key-bits leaked in different clock cycles in different bench marks, which can be detected by the exemplary SMV. The exemplary leakage detection capability of the SMV in different clock cycles can be dependent on the amount of memory needed to reach that clock cycle. The exemplary SMV can check for an assertion given to prove the Trojan's presence in every clock cycle, and it can run until it can prove its presence. In all the Trojan benchmarks, the leaks in different clock cycles can be detected, except in AES-T900 where the inverse polarity verification of Trojan can detect only about 32 leaks, and the remaining about 32 leaks cannot be detected because of memory limitations.

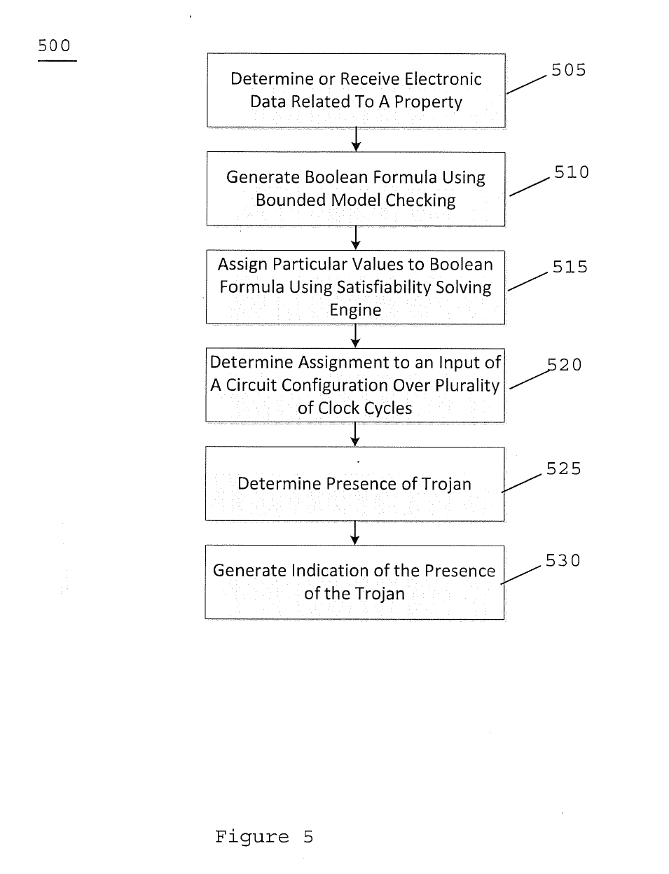

FIG. 5 shows a flow diagram of an exemplary method 500 for determining the presence of a Trojan in a configuration according to an exemplary embodiment of the present disclosure. For example, at procedure 505, electronic data related to a property can be determined or received. At procedure 510, a Boolean formula can be generated using a bounded model checking tool, and particular values can be assigned to the Boolean formula using a satisfiability solving engine at procedure 515. At procedure 520, one or more assignments to an input of a circuit configuration can be determined over a plurality of clock cycle. At procedure 525, the presence of the Trojan can be determined, and an indication of the presence of the Trojan can be generated at procedure 530.

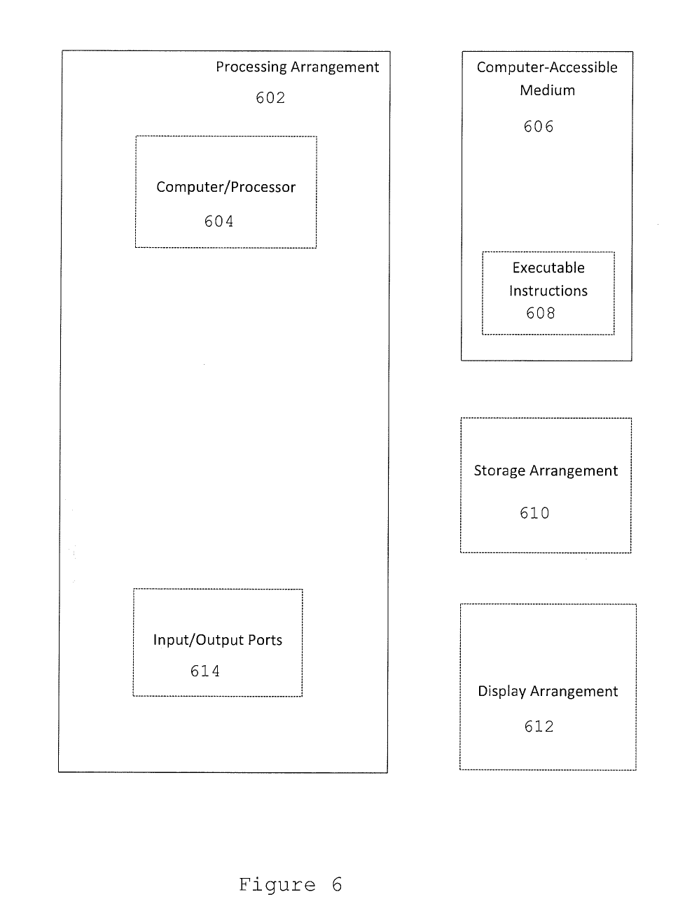

FIG. 6 shows a block diagram of an exemplary embodiment of a system according to the present disclosure. For example, exemplary procedures in accordance with the present disclosure described herein can be performed by a processing arrangement and/or a computing arrangement 602. Such processing/computing arrangement 602 can be, for example entirely or a part of, or include, but not limited to, a computer/processor 604 that can include, for example one or more microprocessors, and use instructions stored on a computer-accessible medium (e.g., RAM, ROM, hard drive, or other storage device).

As shown in FIG. 6, for example a computer-accessible medium 606 (e.g., as described herein above, a storage device such as a hard disk, floppy disk, memory stick, CD-ROM, RAM, ROM, etc., or a collection thereof) can be provided (e.g., in communication with the processing arrangement 602). The computer-accessible medium 606 can contain executable instructions 608 thereon. In addition or alternatively, a storage arrangement 610 can be provided separately from the computer-accessible medium 606, which can provide the instructions to the processing arrangement 602 so as to configure the processing arrangement to execute certain exemplary procedures, processes and methods, as described herein above, for example.

Further, the exemplary processing arrangement 602 can be provided with or include an input/output arrangement 614, which can include, for example a wired network, a wireless network, the internet, an intranet, a data collection probe, a sensor, etc. As shown in FIG. 6, the exemplary processing arrangement 602 can be in communication with an exemplary display arrangement 612, which, according to certain exemplary embodiments of the present disclosure, can be a touch-screen configured for inputting information to the processing arrangement in addition to outputting information from the processing arrangement, for example. Further, the exemplary display 612 and/or a storage arrangement 610 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entirety.
[1] “Defense Science Board (DSB) study on High Performance Microchip Supply,” http://www.acq.osd.mil/dsb/reports/ADA435563.pdf, 2005.
[2] Bhunia, M. Hsiao, M, Banga, and S. Narasimhan, “Hardware Trojan Attacks: Threat Analysis and Countermeasures,” Proceedings of the IEEE, vol. 102, no. 8, pp. 1229-1247, 2014.
[3] M. Tehranipoor and F. Koushanfar, “A Survey of Hardware Trojan Taxonomy and Detection,” IEEE Design and Test of Computers, vol. 27, no. I, pp. 10-25, 2010.
[4] Wikipedia, “Trustworthy computing.” [Online]. Available: http://en.wikipedia.org/wiki/Trustworthy_computing#cite_note-0
[5] X. Zhang and M. Tehranipoor, “Case study: Detecting hardware Trojans in third-party digital IP cores,” in the Proc. of IEEE International Symposium on Hardware-Oriented Security and Trust, pp. 67-70, 2011.
[6] J. Jou and C. J. Liu, “Coverage analysis techniques for HDL design validation,” IEEE Asia Pacific Conference on Chip Design Languages, 1999.
[7] A. Waksman, M. Suozzo, and S. Sethumadhavan, “FANCI: Identification of Stealthy Malicious Logic Using Boolean Functional Analysis,” ACM Conference on Computer & Communications Security, pp. 697-708, 2013.
[8] H. Salmani and M. Tehranipoor, “Analyzing circuit vulnerability to hardware Trojan insertion at the behavioral level,” IEEE International Symposium on Defect and Fault Tolerance in VLSI and Nanotechnology Systems, pp. 190-195, 2013.
[9] N. G. Tsoutsos, C. Konstantinou, and M. Maniatakos, “Advanced Techniques for Designing Stealthy Hardware Trojans,” IEEEIACM Design Automation Conference, pp. 1-4, 2014.
[10] M. R. Rudra, N. A. Daniel, V. Nagoorkar, and D. H. K. Floe, “Designing Stealthy Trojans with Sequential Logic: A Stream Cipher Case Study,” in the Proc. of the IEEE/ACM Design Automation Conference, pp. 172:1-172:4, 2014.
[11] E. Love, Y. Jin, and Y. Makris, “Proof-Carrying Hardware Intellectual Property: A Pathway to Trusted Module Acquisition,” IEEE Transactions on Information Forensics and Security, vol. 7, no. 1, pp. 25-40, 2012.
[12] M. “Tehranipoor, R. Karri, F. Koushanfar, and M. Potkonjak, “Trusthub,” lutp://trust-hub.org.
[13] “NYU-Embedded Systems Challenge,” http://isis.poly.edu/esc/.
[14] Y. Liu, Y. Jin, and Y. Makris, “Hardware Trojans in wireless crypto-graphic ICs: Silicon demonstration and detection method evaluation,” IEEE/ACM International Conference on Computer-Aided Design, pp. 399-404, 2013.
[15] Y. Jin and Y. Makris, “Hardware Trojans in Wireless Cryptographic ICs,” IEEE Design & Test of Computers, vol. 27, no. 1, pp. 26-35, 2010.
[16] L. Lin, W. Burleson, and C. Paar, “MOLES: Malicious off-chip leakage enabled by side-channels,” IEEE/ACM International Conference on Computer-Aided Design, pp. 117-122, 2009.
[17] Atmel, “ATSHA204,” http://wwreatrnel.com/devices/atsha204.aspx, 2014.
[18] Freescale, “C29x Family of Crypto Coprocessors,” http://www.freescale.com/webapp/sps/site/taxonomyjsp?code=C29X-FAMILY&cof=0&am=0, 2014.
[19] J. Woodcock, P. G. Larsen, J. Bicarregui, and J. Fitzgerald, “Formal Methods: Practice and Experience,” ACM Computing Surveys, vol. 41, no. 4, pp. 19:1-19:36, 2009.
[20] A. Pnucli, “The temporal semantics of concurrent programs,” in Semantics of Concurrent Computation, ser. Lecture Notes in Computer Science, G. Kahn, Ed. Springer Berlin Heidelberg, 1979, vol. 70, pp. 1-20. [Online]. Available: http://dx.doi.org/10.1007/BFb0022460
[21] L. Lampert, “Proving the Correctness of Multiprocess Programs,” IEEE Transactions on Software Engineering, vol. SE-3, no. 2, pp. 125-143, 1977.
[22] K. L. McMillan, Symbolic Model Checking. Kluwer Academic Publishers, 1993.
[23] E. Clarke, O. Grumberg, and K. Hamaguchi, “Another Look at I TL Model Checking,” Formal Methods in System Design, vol. 10, no. 1, pp. 47-71, 1997.
[24] A. Biere, A. Cimatti, E. Clarke, and Y. Zhu, “Symbolic Model Checking without BDDs,” Tools and Algoritluns, jbr the Construction and Analysis of Systems, vol. 1579, pp. 193-207, 1999.
[25] L. Feiten, M. Sauer, T. Schubert, A. Czutro, E. Bohl, l. Polian, and B. Becker, “#SAT-based vulnerability analysis of security components—A Case Study,” IEEE International Symposium on Defect and Fault Tolerance in VLSI and Nanotechnology Systems, pp. 49-54, 2012.
[26] H. Eldib, C. Wang, and P. Schaumont. “SMT-Based Verification of Software Countermeasures against Side-Channel Attacks,” International Conference on Tools and Algorithms for the Construction and Analysis of Systems, pp. 62-77, 2014.
[27] M. M. Matalgah, W. Zibideh, and A. Magableh, “Alleviating the effect of the strict avalanche criterion (sac) of symmetric-key encryption in wireless communication channels,” pp. 138-141, March 2011.
[28] M. R. Rudra, N. A. Daniel, V. Nagoorkar, and D. H. K. Hoe, “Designing Stealthy Trojans with Sequential Logic: A Stream Cipher Case Study,” IEEE/ACM Design Automation Conference, pp. 1-4, 2014.
[29] “Cadence: Smv,” http://www.cadence.com/products/fv/pages/default.aspx, 2005.

What is claimed is:

1. A non-transitory computer-accessible medium having stored thereon computer-executable instructions for determining a presence of at least one Trojan in at least one configuration, wherein, when a computer arrangement executes the instructions, the computer arrangement is configured to perform procedures comprising:
receiving electronic data related to at least one property; and
determining the presence of the at least one Trojan based on the electronic data the at least one property and at least one design of the at least one configuration using a bounded model checking (BMC) engine.

2. The computer-accessible medium of claim 1, wherein the at least one design includes a software description of the at least one configuration.

3. The computer-accessible medium of claim 1, wherein the determination procedure includes generating at least one Boolean formula using the BMC engine.

4. The computer-accessible medium of claim 3, wherein the computer arrangement is further configured to assign particular values to the at least one Boolean formula using a satisfiability solving engine.

5. The computer-accessible medium of claim 4, wherein the computer arrangement is further configured to generate an indication of the presence of the at least one Trojan if the at least one Boolean formula evaluates to 1 using the particular values.

6. The computer-accessible medium of claim 1, further comprising at least one bound.

7. The computer-accessible medium of claim 6, wherein the determination procedure is further based on the at least one bound.

8. The computer-accessible medium of claim 6, wherein the at least one bound is a particular number of clock cycles.

9. The computer-accessible medium of claim 1, wherein the at least one property includes a detection that the at least one Trojan leaks at least one secret.

10. The computer-accessible medium of claim 1, wherein the at least one property includes a detection that the at least one Trojan leaks at least one subset of the at least one secret.

11. The computer-accessible medium of claim 1, wherein the at least one property includes a detection that the at least one Trojan is triggered over a plurality of clock cycles.

12. The computer-accessible medium of claim 1, wherein the at least one property includes a detection of at least one of at least one direct polarity and at least one indirect polarity.

13. The computer-accessible medium of claim 1, wherein the at least one configuration includes at least one circuit.

14. The computer-accessible medium of claim 1, wherein the computer arrangement is further configured to determine assignments to an input of the configuration over a plurality of clock cycles using the at least one property.

15. The computer-accessible medium of claim 14, wherein the determination procedure utilize a set of inputs over the clock cycles that violate the at least one property.

16. The computer-accessible medium of claim 1, wherein the at least one property includes a strict avalanche criterion property.

17. The computer-accessible medium of claim 16, wherein the computer arrangement is further configured to determine the strict avalanche criterion property.

18. The computer-accessible medium of claim 17, wherein the computer arrangement determines the strict avalanche criterion property using at least two seeds for a pseudo random number generator.

19. A method for determining a presence of at least one Trojan in at least one configuration, comprising:
receiving electronic data related to at least one property; and
using a computer hardware arrangement, determining the presence of the at least one Trojan based on the electronic data the at least one property and at least one design of the at least one configuration using a bounded model checking (BMC) engine.

20. A system for determining a presence of at least one Trojan in at least one configuration, comprising:
a computer hardware arrangement configured to:
receiving electronic data related to at least one property; and
determine the presence of the at least one Trojan based on the electronic data the at least one property and at least one design of the at least one configuration using a bounded model checking (BMC) engine.
